(19) United States
(12) Patent Application Publication
(10) Pub. No.: US 2012/0078484 A1
(43) Pub. Date: Mar. 29, 2012

(54) Vehicle cruise control apparatus

(75) Inventor: Hiroki Kato, Tokyo (JP)

(73) Assignee: Fuji Jukogyo Kabushiki Kaisha, Tokyo (JP)

(21) Appl. No.: 13/137,932

(22) Filed: Sep. 21, 2011

(30) Foreign Application Priority Data
Sep. 27, 2010 (JP) 2010-214856

(51) Int. Cl. B60K 31/02

(52) U.S. Cl. 701/96

(57) ABSTRACT

In a vehicle cruise control apparatus, a cruise control unit determines whether or not a lane in which a subject vehicle is traveling is an overtaking lane. When the cruise control unit determines that the subject vehicle is traveling in an overtaking lane, the cruise control unit sets a target acceleration such that the responsiveness of a subject vehicle speed to an acceleration side is relatively higher than that when the subject vehicle is traveling in a lane other than the overtaking lane (cruising lane).

### CROSS REFERENCES TO RELATED APPLICATIONS

The present application claims priority from Japanese Patent Application No. 2010-214856 filed on Sep. 27, 2010, the entire contents of which are hereby incorporated by reference.

### BACKGROUND OF THE INVENTION

1. Field of the Invention

The present invention relates to a vehicle cruise control apparatus that selectively executes follow-up cruise control for maintaining an inter-vehicle distance from a preceding vehicle or constant speed cruise control for maintaining a set vehicle speed determined by a driver, depending on a detected state of the preceding vehicle.

2. Description of the Related Art

Recently, there have been various proposals for a vehicle driving support device that recognizes outside environment in front of a vehicle by using a millimeter wave radar, an infrared laser radar, a stereo camera, a monocular camera and the like, and performs a cruise control for the vehicle or the like based on the recognized outside environment of the vehicle. As an example of such a cruise control function, a function of performing a follow-up cruise control is widely known, the control following a preceding vehicle when such a vehicle is detected (captured) in front of a subject vehicle.

Typically, the follow-up cruise control has been widely in practical use as part of an adaptive cruise control (ACC). In the ACC, the follow-up cruise control is executed if a vehicle is detected in front of the subject vehicle, and a constant speed cruise control at a set vehicle speed determined by a driver is executed if no preceding vehicle is detected.

In order to perform an acceleration control that reflects the driver's intention in this type of cruise control device, for example, Japanese Unexamined Patent Application Publication (JP-A) No. 2005-335496 discloses a technique that uses a vehicle cruise control apparatus in which a target inter-vehicle distance from a preceding vehicle upon the follow-up cruise control is selectively set to any one of “long,” “moderate” and “short,” and increases responsiveness upon the following cruise control as the target following distance set by the driver is shorter, as an amount of change in the target following distance set by the driver is larger, and as a time interval of the change of the target following distance by the driver is shorter.

However, the technique disclosed in JP-A No. 2005-335496 simply changes acceleration characteristics based on a condition set by the driver, and does not reflect actual driving environment and the like in the acceleration characteristics. Thus, the acceleration control does not necessarily match a driver's feeling.

### SUMMARY OF THE INVENTION

The present invention is made in view of the above, and aims to provide a vehicle cruise control apparatus capable of performing an acceleration control that matches a driver's feeling.

A vehicle cruise control apparatus according to an aspect of the present invention includes a preceding vehicle detector configured to detect a preceding vehicle and selectively executes either of a follow-up cruise control for maintaining an inter-vehicle distance from a preceding vehicle or a constant speed cruise control for maintaining a set vehicle speed determined by a driver, depending on a detected state of the preceding vehicle by way of the preceding vehicle detector. The vehicle cruise control apparatus further includes: a target acceleration setter configured to set a target acceleration for the cruise controls based on the set vehicle speed or a relationship with the preceding vehicle; a lane determiner configured to determine whether or not a lane in which a subject vehicle is traveling is an overtaking lane. When the subject vehicle is determined to be traveling in the overtaking lane, the target acceleration setter sets the target acceleration such that the responsiveness of the subject vehicle speed to an acceleration side upon the cruise controls is relatively higher than that when the subject vehicle is traveling in a lane other than the overtaking lane.

### BRIEF DESCRIPTION OF THE DRAWINGS

FIG. 1 is a schematic configuration diagram of a vehicle cruise control apparatus mounted on a vehicle;

FIG. 2 is a flow chart showing a target acceleration setting routine;

FIG. 3 is a flow chart showing a lane type determining subroutine;

FIG. 4 is a flow chart showing a target acceleration calculating subroutine based on a set vehicle speed;

FIG. 5 is a flow chart showing a target acceleration calculating subroutine based on a preceding vehicle;

FIG. 6 is an explanatory view showing a cruising lane and an overtaking lane on roads;

FIG. 7 is an explanatory view showing maps for setting a target acceleration based on a relative speed and a relative distance; and

FIG. 8 is an explanatory view comparing responsiveness to an acceleration side between cruising lane traveling and overtaking lane traveling.

### DESCRIPTION OF THE PREFERRED EMBODIMENTS

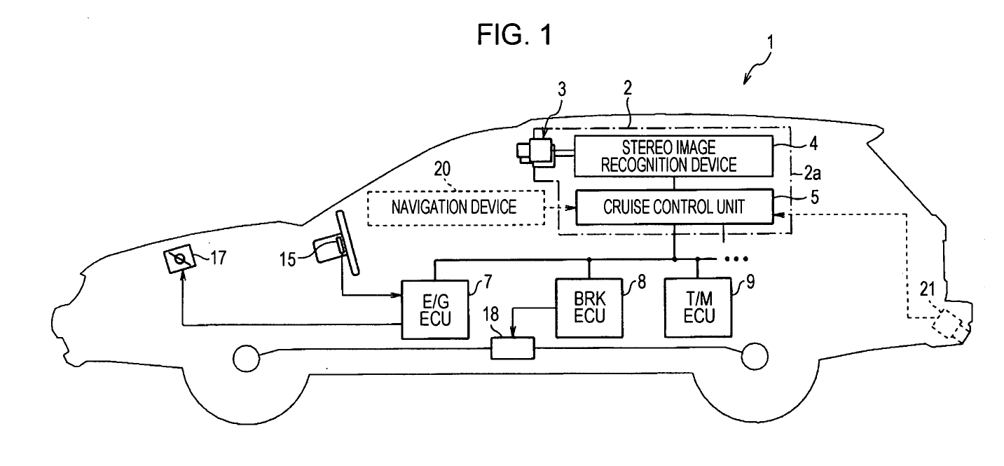

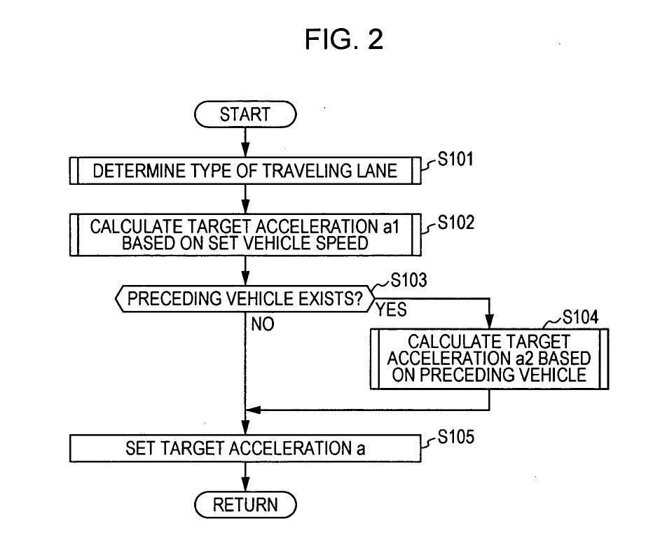

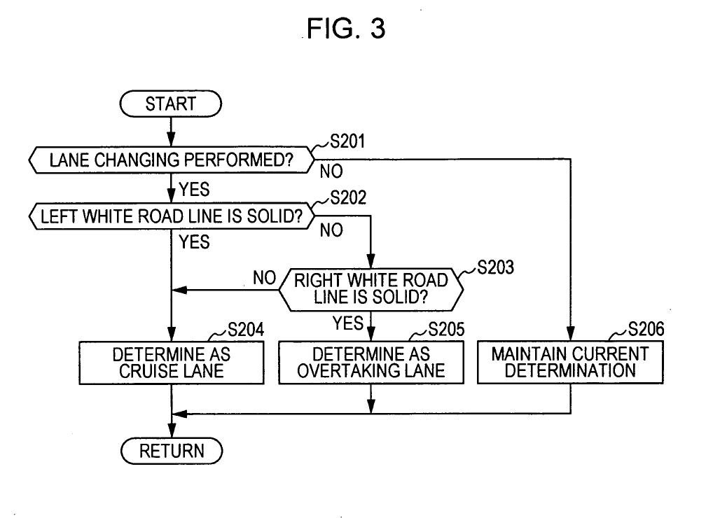

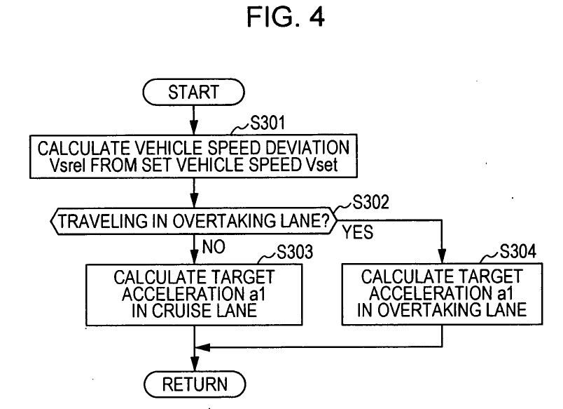

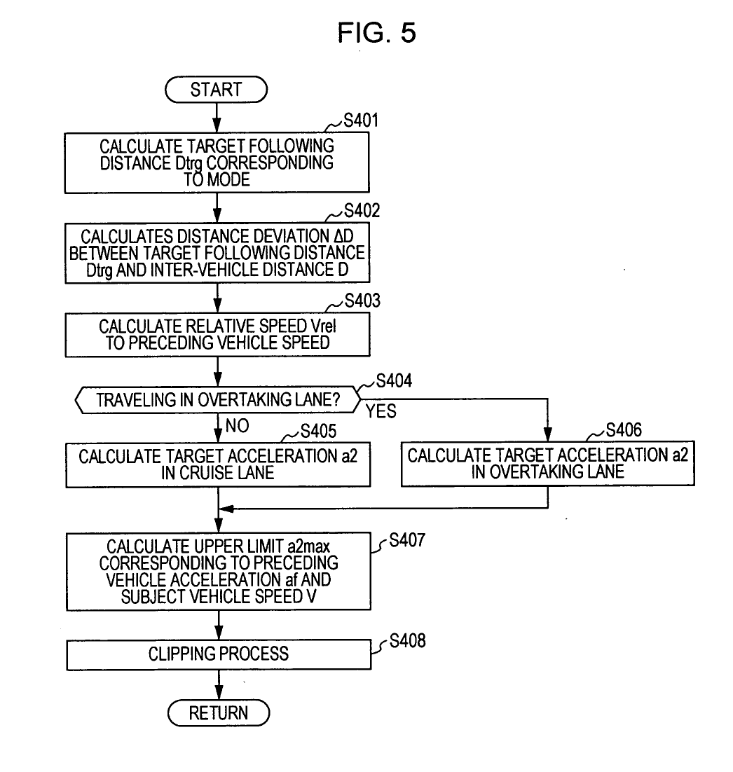

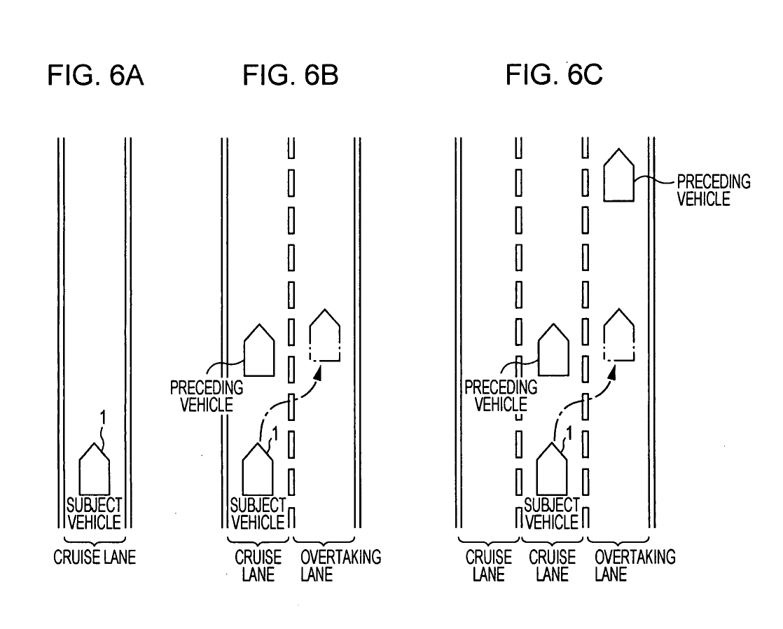

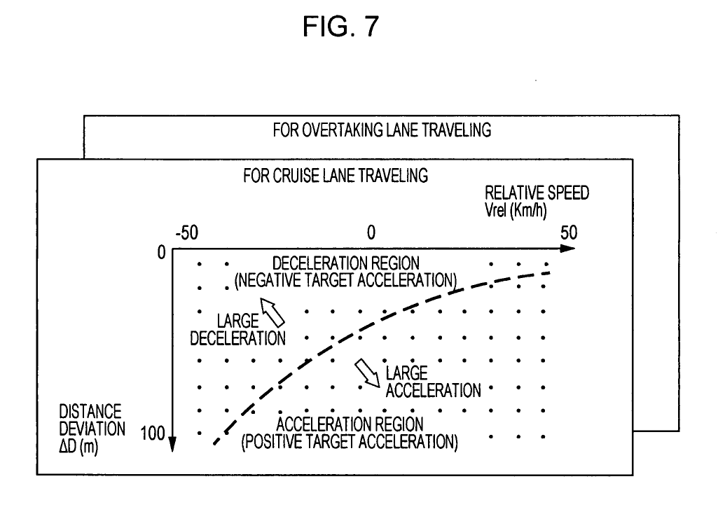

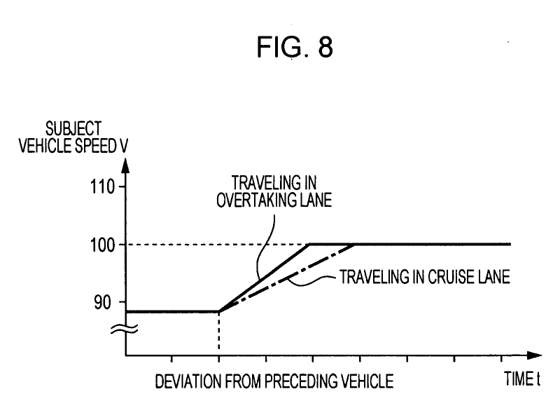

An embodiment of the present invention will hereunder be described with reference to the drawings. The drawings relate to an embodiment of the present invention, in which: FIG. 1 is a schematic configuration diagram of a vehicle cruise control apparatus mounted on a vehicle; FIG. 2 is a flow chart showing a target acceleration setting routine; FIG. 3 is a flow chart showing a lane type determining subroutine; FIG. 4 is a flow chart showing a target acceleration calculating subroutine based on a set vehicle speed; FIG. 5 is a flow chart showing a target acceleration calculating subroutine based on a preceding vehicle; FIGS. 6A to 6C are explanatory views showing cruising lane(s) and an overtaking lane on roads; FIG. 7 is an explanatory view showing maps for setting a target acceleration based on a relative speed and a relative distance; and FIG. 8 is an explanatory view comparing responsiveness to an acceleration side between cruising lane traveling and overtaking lane traveling.

In FIG. 1, reference numeral denotes a vehicle (subject vehicle) such as an automobile, equipped with a cruise control apparatus 2 that has an adaptive cruise control (ACC) function.

The cruise control apparatus 2 is mainly constituted by a stereo camera assembly 2a integrally including, for example, a stereo camera 3, a stereo image recognition device 4, and a cruise control unit 5. The cruise control unit 5 of the stereo camera assembly 2a is connected to onboard control units such as an engine control unit (E/G_ECU) 7, a brake control unit (BRK_ECU) 8, and a transmission control unit (T/M_ECU) 9 such that the units can communicate with one another.

The stereo camera 3 includes, as a stereo optical system, a left and right pair of CCD cameras using solid state imaging devices such as charge-coupled devices (CCDs), for example. The CCD cameras in a pair are attached on front portions of a ceiling in a vehicle compartment with a predetermined space therebetween, capture stereo images of an outside subject from different viewpoints, and output the captured image information to the stereo image recognition device 4.

The stereo image recognition device 4 receives the image information from the stereo camera 3 as well as a subject vehicle speed V and the like from the T/M_ECU 9, for example. The stereo image recognition device 4 recognizes front information such as data on a three-dimensional object and a white road line in front of the subject vehicle 1 based on the image information from the stereo camera 3, and estimates the lane in which the subject vehicle 1 is traveling based on the recognized information. The stereo image recognition device 4 also detects a preceding vehicle traveling in the lane in which the vehicle 1 is traveling, based on the recognized three-dimensional object data and the like. The stereo image recognition device 4 processes the image information from the stereo camera 3 in the following manner, for example. Firstly, the stereo image recognition device 4 generates distance information for a pair of stereo images captured in the traveling direction of the subject vehicle 1 by the stereo camera 3, using an amount of misalignment between corresponding positions in the images according to the principle of triangulation. Then, the image information is subjected to a known grouping process, and the grouped information is compared with three-dimensional road shape data, three-dimensional object data and the like, which are previously stored so as to extract white road line data, side wall data on a guardrail and a curb present along the road, and three-dimensional data on a vehicle and the like. Then, the stereo image recognition device 4 estimates the traveling lane of the subject vehicle 1 based on the white road line data, the side wall data and the like, and extracts (detects), as a preceding vehicle, a three-dimensional object that is present in the traveling lane of the subject vehicle 1 and that moves at a predetermined speed (for example, 0 km/h or higher) in a substantially same direction as the vehicle 1. If a preceding vehicle is detected, the stereo image recognition device 4 calculates preceding vehicle information such as a preceding vehicle distance (inter-vehicle distance) D, a preceding vehicle speed Vf (=(rate of change in the inter-vehicle distance D)+(the subject vehicle speed V)), and a preceding vehicle acceleration of (a differential value of the preceding vehicle speed Vf). In particular, a preceding vehicle that has a speed Vf is a predetermined value or smaller (for example, 4 km/h or lower) and does not accelerate among preceding vehicles is recognized as a preceding vehicle in a stop state. In this manner, together with the stereo camera 3, the stereo image recognition device 4 implements functions of a preceding vehicle detector in the present embodiment.

The white road line that is recognized by the stereo image recognition device 4 refers to a boundary line (lane marking) that is painted on a road so as to define a traveling lane. The white road line may be a solid line or a dashed line, and further includes a yellow line or the like in a broader sense. In the present embodiment, the stereo image recognition device 4 recognizes a white road line including at least the line type thereof such as a solid line and a dashed line.

The cruise control unit 5 receives, for example, recognized information on the outside in front of the subject vehicle 1 from the stereo image recognition device 4, as well as the subject vehicle speed V from the T/M_ECU 9

The cruise control unit 5 also receives, for example, information on settings set by a driver with a cruise control switch 15 via the E/G_ECU 7. In the present embodiment, the cruise control switch 15 is an operation switch including a push switch, a toggle switch and the like disposed on a steering wheel. The cruise control switch 15 has a cruise switch “CRUISE” that is a main switch configured to turn on/off the operation of the ACC, a cancellation switch “CANECEL” for canceling the ACC, a setting switch “SET/−” for setting a current subject vehicle speed as a set vehicle speed Vset, an inter-vehicle distance setting switch for setting a mode for the inter-vehicle distance between a preceding vehicle and the subject vehicle, a resume switch “RES/+” for resetting a previously-stored set vehicle speed Vset. In the present embodiment, the mode for the inter-vehicle distance is set to any one of “long,” “moderate” and “short.” The cruise control unit 5 sets a target following distance Dtrg is different for each of the modes depending on the subject vehicle speed V, for example.

When the cruise switch of the cruise control switch 15 is turned on, the driver sets a desired set vehicle speed Vset through the setting switch or the like, and the mode for setting the target following distance Dtrg is set through the inter-vehicle distance setting switch, the cruise control unit 5 executes the ACC.

When no preceding vehicle is detected by the stereo image recognition device 4, the cruise control unit 5 executes, as the ACC, a constant speed cruise control that matches the subject vehicle speed V to the set vehicle speed Vset by a vehicle speed control through the E/G_ECU 7 and the BRK_ECU 8. Specifically, the cruise control unit 5 calculates a target accelerational for matching the subject vehicle speed V to the set vehicle speed Vset. Then the cruise control unit 5 basically sets the target acceleration a1 as a final target acceleration a and controls the opening degree of an electronic throttle control valve 17 (engine output control) through the E/G_ECU 7 so as to generate an acceleration corresponding to the target acceleration a, and match the subject vehicle speed V to the set vehicle speed Vset. Furthermore, when it is determined that a sufficient acceleration (deceleration) cannot obtained by the engine output control only, the cruise control unit 5 controls a hydraulic pressure output from a brake booster 18 (automatic brake intervention control) through the BRK_ECU so as to match the subject vehicle speed V to the set vehicle speed Vset.

When a preceding vehicle is detected by the stereo image recognition device 4 during the constant speed cruise control, the cruise control unit 5 shifts to a follow-up cruise control. Specifically, when the cruise control unit 5 shifts to the follow-up cruise control, the cruise control unit 5 calculates the above-mentioned target accelerational, as well as a target acceleration a2 for matching the inter-vehicle distance D to the target following distance Dtrg. Then the cruise control unit 5 basically sets the target accelerational or the target acceleration a2, whichever is smaller, as the final target acceleration a, and generates an acceleration corresponding to the target acceleration a by the engine output control, the automatic brake intervention control and the like, thereby matching the inter-vehicle distance D to the target following distance Dtrg.

For a case in which, for example, the subject vehicle 1 enters a curve, is coasting during the constant speed cruise control or the follow-up cruise control, another target acceleration in addition to the above-mentioned target accelerations a1 and a2 may be calculated, and the target acceleration with a minimum value among these target accelerations may be set as the final target acceleration a.

Here, the cruise control unit 5 determines whether or not the lane in which the subject vehicle 1 is traveling is an overtaking lane, based on the recognition information from the stereo image recognition device 4. When the cruise control unit 5 determines that the subject vehicle 1 is traveling in the overtaking lane, the cruise control unit 5 sets the target acceleration a (target accelerations a1 and a2) such that the responsiveness of the subject vehicle speed V to an acceleration side is relatively higher than that when the subject vehicle 1 is traveling in a lane (cruising lane) other than the overtaking lane. Specifically, for example, based on the target accelerations a1 and a2 upon traveling in the cruising line, the cruise control unit 5 sets the target accelerations a1 and a2 upon traveling in the overtaking lane such that positive values of the target accelerations a1 and a2 (values in the acceleration side) are relatively larger than those upon traveling in the cruising lane.

As described above, in this embodiment, the cruise control unit 5 implements the functions of a target acceleration setter and a lane determining setter.

Next, a process for setting a target acceleration executed by the cruise control unit 5 during the ACC will be described hereunder with reference to a flow chart of a target acceleration setting routine shown in FIG. 2.

This routine is repeated every predetermined time. When the routine starts, in step S101 the cruise control unit 5 firstly determines the type of the lane in which the subject vehicle 1 is currently traveling.

The lane type determination is executed according to, for example, a lane type determining subroutine shown in FIG. 3. When the subroutine starts, in step S201 the cruise control unit 5 examines whether or not it is immediately after the subject vehicle 1 has changed the traveling lane (lane changing). Specifically, the cruise control unit 5 determines whether or not lane changing has been performed by examining whether or not the subject vehicle 1 has crossed a white road line, based on, for example, the recognition information from the stereo image recognition device 4.

When the cruise control unit 5 determines in step S201 that it is immediately after the subject vehicle 1 has performed lane changing, the cruise control unit 5 proceeds to step S202, and examines whether or not a left white road line of a new traveling lane of the subject vehicle is a solid line, based on the recognition information from the stereo image recognition device 4.

If the cruise control unit 5 determines in step S202 that the left white road line of the new traveling lane of the subject vehicle is a solid line, the cruise control unit 5 proceeds to step S204.

On the other hand, if the cruise control unit 5 determines in step S202 that the left white road line of the new traveling lane of the subject vehicle is not a solid line (that is, the cruise control unit 5 determines that the left white road line of the new traveling lane is a dashed line), the cruise control unit 5 proceeds to step S203, and examines whether or not a right white road line of the new traveling lane is a solid line.

If the cruise control unit 5 determines in step S203 that the right white road line of the traveling lane of the subject vehicle is not a solid line (that is, the cruise control unit 5 determines that the right white road line of the new traveling lane is a dashed line), the cruise control unit 5 proceeds to step S204.

When the cruise control unit 5 proceeds to step S204 from S202 or step S203, the cruise control unit 5 determines that the lane in which the subject vehicle 1 is currently traveling is a cruise lane, and then exits the subroutine.

More specifically, for example, even if a road is any one of a one-lane road, a two-lane road, and a three-lane road, the left white road line of the leftmost lane is generally a solid line as far as there is no fork road or the like, as shown in FIGS. 6A to 6C. Accordingly, when the left white road line is determined to be a solid line in step S202, it can be determined that the type of the lane in which the subject vehicle 1 is traveling is a cruise lane. Furthermore, for example, on a three-lane road shown in FIG. 6C, both the left and right white road lines of the lane in the center thereof are generally dashed lines except for a zone in which lane changing is prohibited or the like. Therefore, when the left and right white road lines are determined to be dashed lines in steps S202 and S203, it can be determined that the type of the lane in which the subject vehicle 1 is traveling is a cruise lane.

On the other hand, if the cruise control unit 5 determines in step S203 that the right white road line of the traveling lane of the subject vehicle is a solid line, the cruise control unit 5 proceeds to step S205, where the cruise control unit 5 determines that the lane in which the subject vehicle 1 is currently traveling is an overtaking lane, and then exits the subroutine.

Specifically, for example, as shown in FIGS. 6B and 6C, an overtaking lane is generally located in the right side of a road that has two or more lanes. In this kind of overtaking lane, except for a fork road, a zone in which lane changing is prohibited, or the like, the left white road line is generally a dashed line, whereas the right white road line is generally a solid line. Therefore, if the left white road line is determined to be a dashed line in step S202, and the right white road line is determined to be a solid line in step S203, it can be determined that the type of the lane in which the subject vehicle 1 is traveling is an overtaking road.

If the cruise control unit 5 determines in step S201 that it is not immediately after the subject vehicle 1 has performed lane changing, the cruise control unit 5 proceeds to step S206 and exits the subroutine, maintaining the currently determined type of lane. In other words, while distinguishing between a cruise lane and an overtaking lane can be basically performed based on the states of left and right white road lines as described above, an erroneous decision may be exceptionally made for a fork road, a zone in which lane changing is prohibited, and the like. Therefore, the cruise control unit 5 prevents an erroneous decision by maintaining the lane type determined immediately after lane changing.

In the case, for example, in which the subject vehicle 1 is equipped with a navigation device 20 and a camera 21 for capturing an image at the rear of the vehicle, shown with dashed lines in FIG. 1, it is possible to determine the lane in which the subject vehicle 1 is currently traveling by obtaining information such as the number of lane in the road on which the subject vehicle 1 is currently traveling based on navigation information and by determining whether or not the subject vehicle 1 has crossed a white road line based on images captured by the camera 21 or the like.

When the cruise control unit 5 proceeds from step S101 to step S102 in the main routine shown in FIG. 2, the cruise control unit 5 calculates the target accelerational based on the set vehicle speed Vset.

The calculation of the target accelerational is executed based on, for example, a flow chart of a target acceleration calculating subroutine in FIG. 4. When the subroutine starts, in step S301 the cruise control unit 5 calculates a vehicle speed deviation Vsrel between the subject vehicle speed V and the set vehicle speed Vset (Vsrel=Vset−V).

In following step S302, the cruise control unit 5 examines whether or not the subject vehicle 1 is traveling in an overtaking lane based on the determination result in above-mentioned step S101. If it is determined that the subject vehicle 1 is not traveling in an overtaking lane (that is, traveling in a cruise lane), the cruise control unit 5 proceeds to step S303. If it is determined that the subject vehicle 1 is traveling in an overtaking lane, the cruise control unit 5 proceeds to step S304.

When the cruise control unit 5 proceeds from step S302 to step S303, the cruise control unit 5 calculates the target accelerational using, for example, the vehicle speed deviation Vsrel and the subject vehicle speed V as parameters, and then exits the subroutine. Specifically, a map for cruise lane traveling that uses, for example, the vehicle speed deviation Vsrel and the subject vehicle speed V as parameters is previously set and stored in the cruise control unit 5, and the cruise control unit 5 calculates the target accelerational referring to the map. When, for example, the vehicle speed deviation Vsrel takes a positive value, the target accelerational is set to a larger value based on the subject vehicle V within a range with an upper limit previously set, as the vehicle speed deviation Vsrel becomes larger. When the vehicle speed deviation Vsrel takes a negative value, on the other hand, the target accelerational is set to a smaller value based on the subject vehicle V within a range with a lower limit that is previously set, as the vehicle speed deviation Vsrel becomes smaller (the target accelerational is set to a larger value as a deceleration as the vehicle speed deviation Vsrel becomes larger in the negative side).

When the cruise control unit 5 proceeds from step S302 to step S304, the cruise control unit 5 calculates the target accelerational using, for example, the vehicle speed deviation Vsrel and the subject vehicle speed V as parameters, and then exits the subroutine. Specifically, a map for overtaking lane traveling that uses, for example, the vehicle speed deviation Vsrel and the subject vehicle speed V as parameters is previously set and stored in the cruise control unit 5, and the cruise control unit 5 calculates the target accelerational referring to the map. When, for example, the vehicle speed deviation Vsrel takes a positive value, the target accelerational is set to a larger value within the range of an upper limit previously set in accordance with the subject vehicle V, as the vehicle speed deviation Vsrel becomes larger. Note that the target accelerational is set to a larger value than a corresponding value in the map for cruise lane traveling. When the vehicle speed deviation Vsrel takes a negative value, the target accelerational may be set to a same value as a corresponding value in the map for cruise lane traveling.

When the cruise control unit 5 proceeds to from step S102 to step S103 in the main routine shown in FIG. 2, the cruise control unit 5 examines whether or not a preceding vehicle is detected ahead in the traveling lane of the subject vehicle. When the cruise control unit 5 determines that a preceding vehicle is not detected ahead in the traveling lane of the subject vehicle, the cruise control unit 5 proceeds to step S105.

When a preceding vehicle is detected ahead in step S103, the cruise control unit 5 proceeds to step S104, calculates the target acceleration a2 based on the preceding vehicle, and then proceeds to step S105.

The calculation of the target acceleration a2 is executed based on, for example, a flow chart of a target acceleration calculating subroutine. When the subroutine starts, in step S401 the cruise control unit 5 calculates the target following distance Dtrg corresponding to a currently-set mode for the inter-vehicle distance. Specifically, for example, a map for setting the target following distance Dtrg using the subject vehicle speed V as a parameter when the mode is set to “short,” and a map for setting the target following distance Dtrg using the subject vehicle speed V as a parameter when the mode is set to “long” are previously set and stored in the cruise control unit 5. The maps are set such that the target following distance Dtrg becomes longer as the subject vehicle speed V becomes higher, and such that the target following distance Dtrg for the “long” mode is set relatively longer than that for the “short” mode if the subject vehicle speed V is equal. When the mode is set to “long” or “short,” the cruise control unit 5 sets the target following distance Dtrg based on the subject vehicle speed V using the corresponding map. When the mode is set to “moderate,” the cruise control unit 5 sets the target following distance Dtrg to an intermediate value between the target following distances Dtrg for the “long” mode and for the “short” mode, which are respectively calculated based on the subject vehicle speed V.

In subsequent step S402, the cruise control unit 5 calculates a distance deviation AD between the target following distance Dtrg and the inter-vehicle distance D (=Dtrg−D).

Subsequently, the cruise control unit 5 proceeds from step S402 to step S403, and calculates a relative speed Vrel between the preceding vehicle speed Vf and the subject vehicle speed V (=Vf−V). Then the cruise control unit 5 proceeds to stet S404.

In step S404, the cruise control unit 5 examines whether or not the subject vehicle 1 is traveling in an overtaking lane. If it is determined that the subject vehicle 1 is not traveling in an overtaking lane (that is, traveling in a cruise lane), the cruise control unit 5 proceeds to step S405. If it is determined that the subject vehicle 1 is traveling in an overtaking lane, the cruise control unit 5 proceeds to step S406.

When the cruise control unit 5 proceeds from step S404 to step S405, the cruise control unit 5 calculates the target acceleration a2, using, for example, the distance deviation ΔD and the relative speed Vrel as parameters, and then proceeds to step S407. Specifically, for example, the cruise control unit 5 stores a map for cruise lane traveling shown in FIG. 7. The map uses, for example, the distance deviation ΔD and the relative speed Vrel as parameters to set a value of the target acceleration a2 on grid points. The cruise control unit 5 calculates the target acceleration a2 by referring to the map. As shown in FIG. 7, the map sets an acceleration region and a deceleration region are for cruise lane traveling, based on the distance deviation ΔD and the relative speed Vrel. The target acceleration a2 is set to an acceleration value (positive value) in the acceleration region, while the target acceleration a2 is set to a deceleration value (negative value) in the deceleration region. In the acceleration region, the target acceleration a2 is set to a lager value (a larger value as an acceleration) as the relative speed Vrel becomes larger and the distance deviation AD becomes larger. In the deceleration region, on the other hand, the target acceleration a2 is set to a smaller value (a larger deceleration value) as the relative speed Vrel becomes smaller (the relative speed Vrel becomes larger in the negative side) and the distance deviation AD becomes smaller.

When the cruise control unit 5 proceeds from step S404 to step S406, the cruise control unit 5 calculates the target acceleration a2, using, for example, the distance deviation ΔD and the relative speed Vrel as parameters, and then proceeds to step S407. Specifically, for example, the cruise control unit 5 stores a map for overtaking lane traveling shown in FIG. 7. The map uses, for example, the distance deviation ΔD and the relative speed Vrel as parameters to set a value of the target acceleration a2 on grid points. The cruise control unit 5 calculates the target acceleration a2 by referring to the map. As shown in FIG. 7, an acceleration region and a deceleration region are set on the map for overtaking lane traveling, based on the distance deviation ΔD and the relative speed Vrel, like the map for cruise lane traveling. In the acceleration region, the target acceleration a2 is set to be a lager value (a larger value in the acceleration side) as the relative speed Vrel becomes larger and the distance deviation AD becomes larger. In the deceleration region, on the other hand, the target acceleration a2 is set to be a smaller value (a larger value in the deceleration side) as the relative speed Vrel becomes smaller (the relative speed Vrel becomes larger in the negative side) and the distance deviation AD becomes smaller. Note that the target acceleration a2 set in the acceleration region on the map for overtaking lane traveling is set to a value relatively larger than a corresponding value in the map for cruise lane traveling.

When the cruise control unit 5 proceeds from step S405 or step S406 to step S407, the cruise control unit 5 calculates an upper limit a2max of the target acceleration a2, using, for example, the preceding vehicle acceleration af and the subject vehicle speed V as parameters, and then proceeds to step S408. Specifically, for example, a map for setting the upper limit using, for example, the preceding vehicle acceleration af and the subject vehicle speed V as parameters is previously set and stored in the cruise control unit 5. The cruise control unit 5 calculates the upper limit a2max by referring to the map.

When the cruise control unit 5 proceeds from step S407 to step S408, the cruise control unit 5 performs an upper-limit process (clipping process) to the target acceleration a2 calculated in step S405 or step S406, using the upper limit a2max. Then the cruise control unit 5 exits the subroutine.

When the cruise control unit 5 proceeds from step S103 or step S104 to step S105 in the main routine shown in FIG. 2, the cruise control unit 5 sets the final target acceleration a based on the target accelerational and the target acceleration a2, and then exits the routine. Accordingly, since the target acceleration a2 is not set upon the constant speed cruise control in which no preceding vehicle is detected, the cruise control unit 5 sets the target accelerational, which is based on the set vehicle speed sets, as the final target acceleration a. On the other hand, upon the follow-up cruise control in which a preceding vehicle is detected, the cruise control unit 5 sets the target accelerational or the target acceleration a2, whichever is smaller, as the final target acceleration. If another target acceleration in addition to the above-mentioned target accelerations a1 and a2 is set in the routine for the case in which the subject vehicle 1 enters a curve, is coasting, or the like, the target acceleration with a minimum value among these target accelerations may be set as the final target acceleration a. The description for this case is omitted.

According to the embodiment, it is examined whether or not the subject vehicle 1 is traveling in an overtaking lane. If the subject vehicle 1 is determined to be traveling in the overtaking lane, the final target acceleration a is set such that the responsiveness of the subject vehicle speed V to the acceleration side is relatively higher than that when the subject vehicle 1 is traveling in a lane other than the overtaking lane (cruising lane). As a result, an acceleration control that matches a driver's feeling can be performed.

In other words, when the subject vehicle 1 performs lane changing to an overtaking lane, the target acceleration a is set based on characteristics of the target acceleration a upon cruise lane traveling such that the responsiveness of the change in the subject vehicle speed V to the acceleration side is relatively high, thereby achieving a cruise control that fits an actual traveling situation. Specifically, for example, supposing that the subject vehicle 1, following a preceding vehicle in a cruising lane, performs lane changing to an overtaking lane, and that as a result a departure from the preceding vehicle is determined, and follow-up cruise is shifted to constant speed cruise, acceleration to a set vehicle speed can be performed in a relatively shorter time than when the subject vehicle 1 is traveling in an cruising lane. Furthermore, for example, if a preceding vehicle is detected when the subject vehicle 1 performs lane changing from a cruising lane to an overtaking lane, the inter-vehicle distance D can be matched to the target following distance Dtrg in a relatively shorter time than when the subject vehicle 1 is traveling in a cruising lane. Hence, in a cruising lane, acceleration performance with high responsiveness can be delivered, achieving traveling that is appropriate to the course of another vehicle and the like, while discomfort felt by the driver due to excessive acceleration can be prevented (see FIG. 8).

In the aforementioned embodiment, two different maps with different characteristics are used for setting the target accelerational and the target acceleration a2 respectively, but the present invention is not limited thereto. For example, the target accelerational and the target acceleration a2 for overtaking lane traveling may be set by multiplying the target accelerational and the target acceleration a2, which are set upon cruising lane traveling, with a predetermined gain (>1).

Further, in order to make responsiveness to speed change in a cruising lane different from that in an overtaking lane especially upon the follow-up cruise control, for example, when the cruise control unit 5 determines that the subject vehicle 1 is traveling in an overtaking lane, a target inter-vehicle distance may be set relatively shorter than that when the subject vehicle 1 is traveling in a lane other than the overtaking lane (such as cruising lane).

Furthermore, in a three-or-more lane road that has two or more cruising lanes, for example, the target acceleration a1 and the target acceleration a2 upon cruising lane traveling may respectively have graded values. Specifically, based on the target accelerational and the target acceleration a2 in the leftmost cruising lane of the road, the target accelerational and the target acceleration a2 may be set to have a larger value in a cruising lane closer to the overtaking lane.

The aforementioned embodiment describes a vehicle cruise control apparatus for a region where traffic regulations require left-hand traffic. It will be apparent that, in a region where traffic regulations require right-hand traffic, left and right settings and the like can be replaced with each other accordingly.

Furthermore, the present invention is not limited to the aforementioned embodiment, and various changes may be made without departing from the scope of the invention. For example, the configuration of the preceding vehicle detector is not limited to that of the aforementioned embodiment using the stereo camera, and may appropriately have a millimeter wave radar, an infrared laser radar, a monocular camera and the like.

What is claimed is:

1. A vehicle cruise control apparatus that includes a preceding vehicle detector configured to detect a preceding vehicle and selectively executes either of a follow-up cruise control for maintaining an inter-vehicle distance from a preceding vehicle or a constant speed cruise control for maintaining a set vehicle speed determined by a driver, depending on a detected state of the preceding vehicle by way of the preceding vehicle detector, the vehicle cruise control apparatus comprising:
a target acceleration setter configured to set a target acceleration for the cruise controls based on the set vehicle speed or a relationship with the preceding vehicle; and
a lane determiner configured to determine whether or not the lane in which a subject vehicle is traveling is an overtaking lane;
wherein when the subject vehicle is determined to be traveling in the overtaking lane, the target acceleration setter sets the target acceleration such that the responsiveness of a subject vehicle speed to an acceleration side upon the cruise controls is relatively higher than that when the subject vehicle is traveling in a lane other than the overtaking lane.

2. The vehicle cruise control apparatus according to claim 1, wherein the lane determiner determines the type of the lane in which the subject vehicle is traveling based on forms of white road lines constructed on the left and right sides of the lane in which the subject vehicle is traveling.

3. The vehicle cruise control apparatus according to claim 1, further comprising a target inter-vehicle distance setter configured to set a target inter-vehicle distance upon the follow-up cruise control, wherein when the subject vehicle is determined to be traveling in the overtaking lane, the target inter-vehicle distance setter sets the target inter-vehicle distance to be relatively shorter than an inter-vehicle distance when the subject vehicle is traveling in a lane other than the overtaking lane.

4. The vehicle cruise control apparatus according to claim 2, further comprising a target inter-vehicle distance setter configured to set a target inter-vehicle distance upon the follow-up cruise control, wherein when the subject vehicle is determined to be traveling in the overtaking lane, the target inter-vehicle distance setter sets the target inter-vehicle distance to be relatively shorter than an inter-vehicle distance when the subject vehicle is traveling in a lane other than the overtaking lane.
